(19) United States
(12) Patent Application Publication
(10) Pub. No.: US 2017/0059088 A1
(43) Pub. Date: Mar. 2, 2017

(54) PERSONAL VIEWING OF A MOBILE DEVICE SYSTEM AND METHOD

(71) Applicant: Marlon Galvez, Chicago, IL (US)

(72) Inventor: Marlon Galvez, Chicago, IL (US)

(21) Appl. No.: 15/253,660

(22) Filed: Aug. 31, 2016

Related U.S. Application Data
(60) Provisional application No. 62/212,808, filed on Sep. 1, 2015.

(51) Int. Cl. F16M 13/04; H04M 1/04; F16M 11/32; F16M 11/14; F16M 11/04

(52) U.S. Cl. CPC F16M 13/04; F16M 11/14; F16M 11/041; F16M 11/32; H04M 1/04

(57) ABSTRACT

A stand for personal viewing of a mobile device. The stand for personal viewing of a mobile device includes a tripod, a user-interface, and a pivoting head mount. The stand for personal viewing of a mobile device is useful for orienting a mobile device for a user to view the mobile device screen without holding the mobile device in their hands.

### CROSS-REFERENCE TO RELATED APPLICATION

The present application is related to and claims priority from prior provisional application Ser. No. 62/212,808, filed Sep. 1, 2015 which application is incorporated herein by reference.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of elevating devices and more specifically relates to personal tri-pod systems.

2. Description of Related Art

Many people use their mobile device to read or to view videos, movies, and the like. To assure proper orientation of the mobile device in a viewing position, the mobile device needs to be placed at or near the viewer's eye level. Often, the viewer will hold the mobile device in one or both hands to obtain the viewing position, but over time, the user's hands and arms may become fatigued which may detract from, and ultimately end the viewing session. A suitable solution is desired.

Several attempts have been made to solve the above-mentioned problems such as those found in U.S. Pat. and Pub. Nos. U.S. Pat. No. 7,290,740 to Joy, et al. U.S. Pat. No. 8,746,638 to Carney; U.S. Pat. No. 8,303,126 to Moya, Jr.; U.S. Pat. No. 8,616,508 to Coleman; D741,397 to Minn, et al.; 2010/0314508 to Bevirt; 2007/0249389 to Hotta; and 2015/0076296 to Yang. This art is representative of elevating devices. However, none of the above inventions and patents, taken either singly or in combination, is seen to describe the invention as claimed.

### BRIEF SUMMARY OF THE INVENTION

In view of the foregoing disadvantages inherent in the known elevating devices art, the present invention provides a novel hands free phone entertainment system. The general purpose of the present invention, which will be described subsequently in greater detail is to provide a hands free phone entertainment system.

A stand for personal viewing of a mobile device is disclosed herein. The stand for personal viewing of a mobile device includes a tripod, a user-interface, and a pivoting head mount, useful for orienting a mobile device for a user to view the mobile device screen without holding the mobile device in their hands. The tripod includes three support legs, three pivots, and a base mount. The three support legs are fixed to the base mount and circumferentially distributed about a center-axis. Each support leg further has a base-end and a device-end, and is extendable between a minimum length and a maximum length, respectively. The maximum length of each support leg is at least two times the minimum length in preferred embodiments. Each base-end of each support leg is further configured to pivot radially outward from the center-axis via a pivot proximate to the device-end.

The user-interface of the stand for personal viewing of a mobile device includes a plurality of non-slip pads, with each non-slip pad being coupled to the base-end of one of the three support legs, respectively. In addition, each non-slip pad is configured to rest on a user.

The pivoting head mount of the stand for personal viewing of a mobile device is coupled to the base mount, with the pivoting head mount being configured to retain a mobile device to the base mount. Further, the pivoting head mount is able to provide at least two degrees of freedom of movement, including pan and tilt, while being retained to the base mount.

According to another embodiment, the stand for personal viewing of a mobile device includes a tripod, a user interface, and a pivoting head mount. According to this embodiment, each support leg of the tripod includes a first telescopic leg section that is configured to slide within a second telescopic leg section, respectively. Each support leg is configured to be placed in a retracted position, corresponding to a minimum length, and an extended position, corresponding to a maximum length. The minimum length of each of the three support legs is approximately 8 inches, and the maximum length of each of the three support legs is at least 18 inches. Further, the first telescopic leg section is configured to lock in an extended position, and alternatively in a retracted position, via a toolless locking mechanism. In addition, the three support legs are configured to retract radially inward toward the center-axis such that the three support legs are stowed in a substantially parallel position with the center-axis. Finally, the three support legs are at least partially made of metal, and alternatively, composite materials, and are configured to provide a durable support for the pivoting head mount.

According to this embodiment, the user-interface includes a plurality of non-slip pads with each non-slip pad being structured and arranged to adjust from a first orientation to at least a second orientation in relation to its respective support leg. The first orientation and the second orientation pivotably range between 0 degrees and 180 degrees, such that each support leg is able to sustain contact on a body part of the user. Each non-slip pad is further configured to sustain contact with a plurality of body parts of the user, concurrent with each non-slip pad having an independent orientation, and while the plurality of body parts of the user are in motion. In addition, each non-slip pad includes a curved base that is configured to conform to the leg of the user. The at least one non-slip pad is further configured to removably attach to an article of clothing worn by the user with the inclusion of at least one clip, and alternatively a hook. Other securing means may be used.

According to this embodiment, the pivoting head mount is configured to hold the mobile device in a selectably fixed orientation facing the user. The pivoting head mount includes a horizontal member, a vertical member, and a device lock. The horizontal member includes a first U-shaped channel that is configured to removably retain a first edge of the mobile device and inhibit motion along a first axis. The vertical member includes a second U-shaped channel that is configured to removably retain a second edge of the mobile device and inhibit motion along a second axis, with the second axis being orthogonal in orientation to the first axis. The device lock is configured to selectably lock the mobile device into at least one of the first U-shaped and the second U-shaped channels. Further, the horizontal member, the vertical member, and the device lock are at least partially made of flexible elastomeric materials and are configured for repeated engagement and disengagement of the mobile device, without introduction of fatigue cracking of the horizontal member, vertical member, and device lock. In addition, the pivoting head mount is configured to selectably tilt the mobile device 180 degrees through 360 degrees of pan. In addition, the pivoting head mount is configured to removably-retain a plurality of cell phone types, and alternatively tablet device, types.

According to another embodiment, a method for using a stand for personal viewing of a mobile device is also disclosed herein. The method for providing a stand for personal viewing of a mobile device includes the steps of: pivoting each support leg radially outward from a center-axis via a pivot proximate to the device-end; extending each support leg to a desired extended position; locking each support leg via a toolless locking mechanism; engaging a mobile device into the first U-shaped channel and second U-shaped channel of the pivoting head mount; and securing the mobile device with the device lock. The method of using a stand for personal viewing of a mobile device further includes the steps of: disengaging the device lock; removing the mobile device from the first U-shaped channel and the second U-shaped channel; retracting each support leg; and pivoting each support leg radially inward toward the center-axis.

The present invention holds significant improvements and serves as a personal tri-pod system. Preferably, elevating devices should provide a hands-free mobile device holder and, yet would operate reliably and be manufactured at a modest expense. Thus, a need exists for a reliable personal tri-pod system to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, hands free phone entertainment system, constructed and operative according to the teachings of the present disclosure.

FIGS. 1A and 1B are perspective views of the stand for personal viewing of a mobile device during an ‘in-use’ condition, according to an embodiment of the disclosure.

FIG. 2 is a perspective view of the stand for personal viewing of a mobile device of FIG. 1, according to an embodiment of the present disclosure.

FIGS. 3A and 3B are perspective views of the stand for personal viewing of a mobile device of FIG. 1, according to an embodiment of the present disclosure.

FIG. 4 is a perspective view of the stand for personal viewing of a mobile device of FIG. 1, according to an embodiment of the present disclosure.

FIG. 5 is a flow diagram illustrating a method of use for personal viewing of a mobile device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to elevating devices and more particularly to a hands free phone entertainment system as used to improve personal viewing of a mobile device.

Generally, a smartphone is a mobile phone with an advanced mobile operating system that combines some features of a personal computer operating system with other features useful for mobile, or handheld, use. Smart phones typically combine the features of a cell phone with those of other popular mobile devices, such as a personal digital assistant (PDA), a media player, and a GPS navigation unit. In addition, smartphones are able to access the internet, have a touchscreen user interface, can run third-party apps, are music players, and include a camera. Stands are available to hold items, such as a camera, in position for use, but they are not designed for holding a smartphone. The present disclosure provides smartphone users with a tripod stand that is able to keep the smartphone stable while at a comfortable eye-level for a more convenient viewing experience. This allows users to watch videos, read, and perform other actions with their smartphone in a hands-free manner which may reduce resulting discomfort and hand cramping if the smartphone user is using their smartphone for a long period of time.

As designed, the tripod stand features three extendable legs and a free-rotating support system designed for securing a smartphone. The extendable legs may be extended with a range between 8″ and 18″. The legs and support system can be adjusted as needed to provide a comfortable, eye-level viewing height of an attached smartphone. The support system may be located at the top of the device and any type of smartphone may be placed within the support system. The securer used to secure the smartphone within the support system may measure approximately 1″ in length and 1″ in width. After a smartphone is secured within the support system, the user may rest the legs of the tripod on their thigh or stomach area. In addition, the tripod stand can be constructed using metal, plastic, and other suitable materials. Further, the tripod stand includes a clip on the tripod legs with which users can attach the tripod stand to their pants or belt to prevent it from falling over during use.

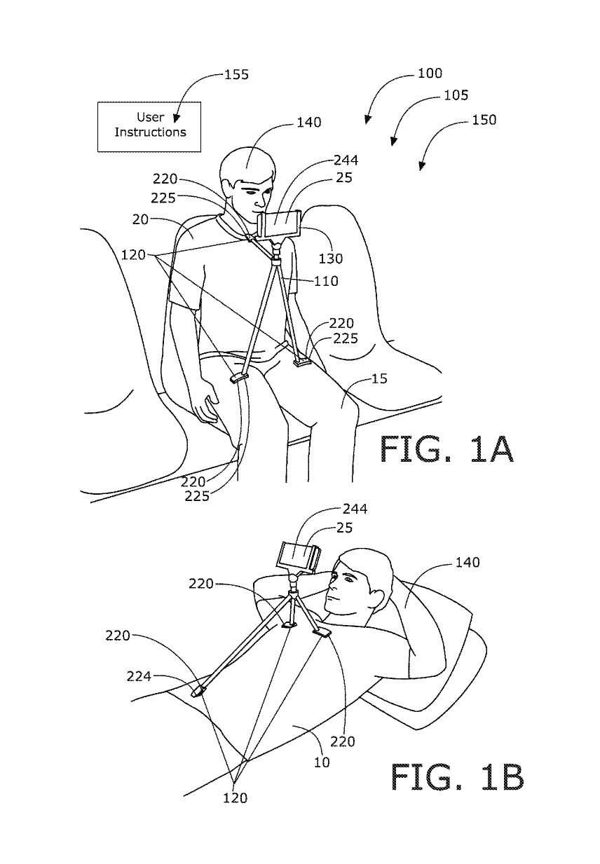

Referring now more specifically to the drawings by numerals of reference, there is shown in FIGS. 1A-4, various views of a stand for personal viewing of a mobile device 100. FIGS. 1A and 1B are perspective views showing a stand for personal viewing of a mobile device during an ‘in-use’ condition 150, according to an embodiment of the present disclosure. Here, the stand for personal viewing of a mobile device may be beneficial for use by a user 140 to view the screen of a mobile device without holding the mobile device in their hands.

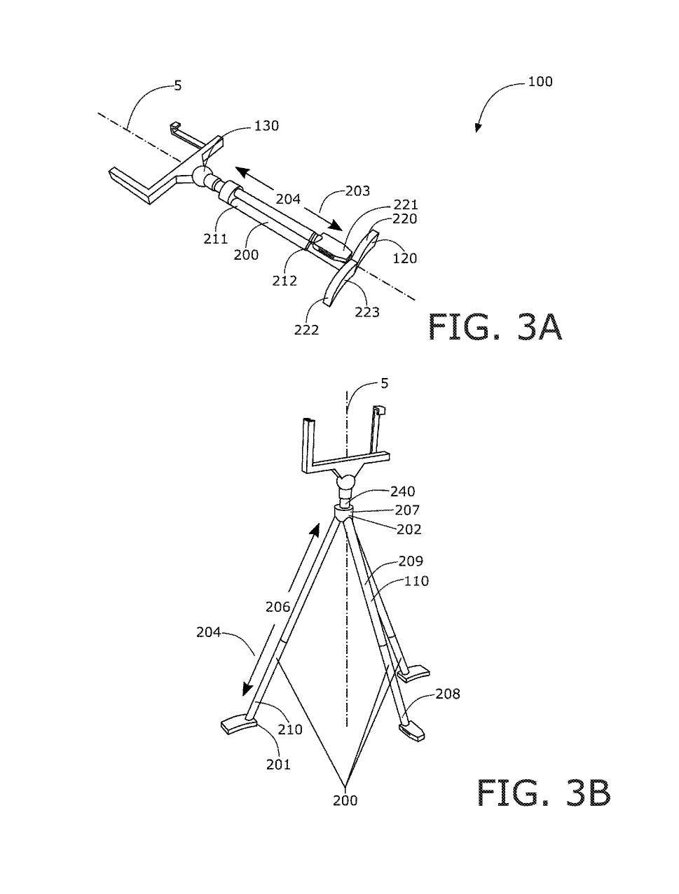

Referring now to FIG. 1A, as illustrated, the a stand for personal viewing of a mobile device 100 may include tripod 110, user-interface 120, and pivoting head mount 130 in structural and functional combination to allow user 140 to engage with tripod 110 while in a seated position and placing mobile device 25 in a selectably fixed orientation 244 facing user 140. Stand for personal viewing of a mobile device 100 may be configured for repeated engagement and disengagement of mobile device 25. Tripod 110 may include three support legs 200 (FIG. 3B) with at least one non-slip pad 220 being coupled to base-end 201 (FIG. 3B) of each of three support legs 200 (FIG. 3B). Each non-slip pad 220 includes curved base 225 that is configured to conform to leg 15 of user 140. In addition, at least one non-slip pad 220 is further configured to removably attach to an article of clothing 20 worn by user 140 with inclusion of at least one clip 226, and alternatively a hook 227.

In now referring to FIG. 1B, showing stand for personal viewing of a mobile device 100 in an alternative ‘in-use’ condition with mobile device 25 in a selectably fixed orientation 244 facing user 140, while user 140 is reclined in a prone position. User-interface 120 of stand for personal viewing of a mobile device 100 may include non-slip pads 220 configured to sustain contact with plurality of body parts 10 of user 140, concurrent with each non-slip pad 220 having an independent orientation 224, and while plurality of body parts 10 of user 140 may be in motion.

According to one embodiment, the stand for personal viewing of a mobile device 100 may be arranged as a kit 105. In particular, the stand for personal viewing of a mobile device 100 may further include a set of instructions 155. The instructions 155 may detail functional relationships in relation to the structure of the stand for personal viewing of a mobile device 100 (such that the stand for personal viewing of a mobile device 100 can be used, maintained, or the like, in a preferred manner).

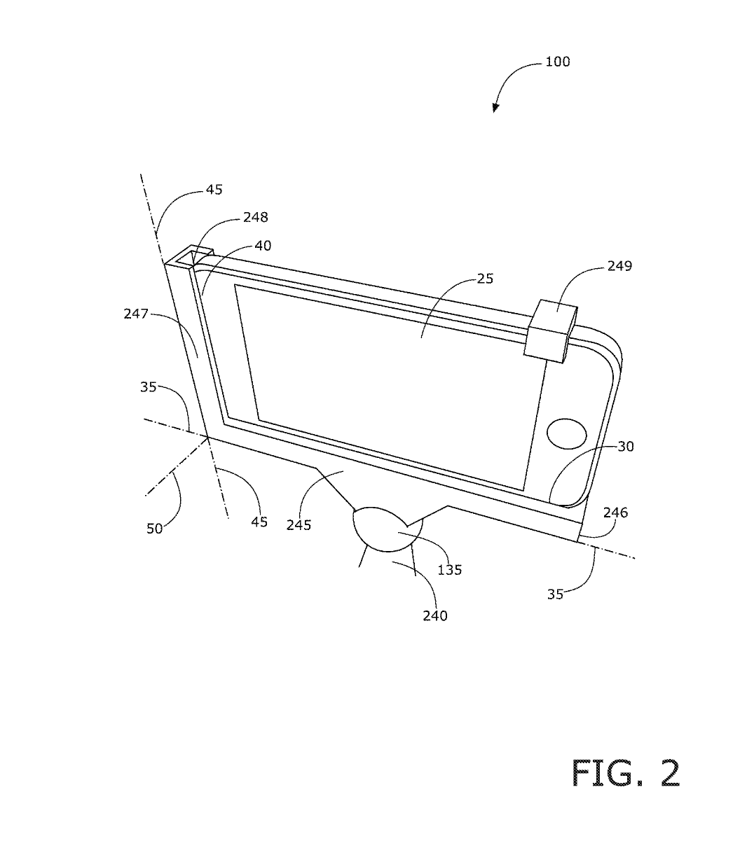

FIG. 2 shows the stand for personal viewing of a mobile device of FIG. 1A, according to an embodiment of the present disclosure. As above, the stand for personal viewing of a mobile device 100 may include may include pivoting head mount 130. Pivoting head mount 130 is configured to hold mobile device 25 in selectably fixed orientation 244 (FIG. 1A) facing user 140 (FIG. 1A and FIG. 1B). Further, pivoting head mount 130 may be configured for repeated engagement and disengagement of mobile device 25. In addition, pivoting head mount 130 may be configured to retain mobile device 25 to base mount 240.

In continuing to refer to FIG. 2, pivoting head mount 130 may include horizontal member 245, vertical member 247, and device lock 249. Horizontal member 245 may include first U-shaped channel 246 that may be configured to removably retain first edge of mobile device 30 and inhibit motion along first axis 35. Vertical member 247 may include second U-shaped channel 248 that maybe configured to removably retain second edge of mobile device 40 and inhibit motion along second axis 45, with second axis 45 being orthogonal 50 in relation to first axis 35. Further, device lock 249 may be configured to selectably lock mobile device 25 into at least one of first U-shaped channel 246 and second U-shaped channel 248. In continuing to refer to pivoting head mount 130, horizontal member 245, vertical member 247, and device lock 249 are at least partially made of flexible elastomeric materials 250 and are configured for repeated engagement and disengagement of mobile device 25, without introduction of fatigue cracking of horizontal member 245, vertical member 247, and device lock 249. It can be noted that pivoting head mount 130 may be configured to removably-retain a plurality of cell phone types 55, and alternatively tablet device types 60.

FIGS. 3A and 3B are perspective views of the stand for personal viewing of a mobile device 100 of FIG. 1A, according to an embodiment of the present disclosure. In referring now to FIG. 3A, user-interface 120 may include plurality of non-slip pads 220, with each non-slip pad 220 being coupled to base-end 201 of one of three support legs 200, respectively. In addition, each non-slip pad 220 is configured to rest, while having an independent orientation 224 (FIG. 1B), on user 140 (FIG. 1A and FIG. 1B). To configure to the resting position, non-slip pad 220 may be structured and arranged to adjust from first orientation 221 to at least second orientation 222 relative to its respective support leg 200. Further, first orientation 221 and second orientation 222 may pivotably range between 0 degrees and 180 degrees 223 such that each leg support 200 may be able to sustain contact on a body part of user 140 (FIG. 1A and FIG. 1B).

In continuing to refer to FIG. 3A, three support legs 200 may be configured to retract radially inward toward center-axis 5 such that three support legs 200 may be stowed in substantially parallel position that aligns with center-axis 5. Finally, three support legs 200 may be at least partially made of metal 213, and alternatively, composite materials 214, which may enable them to be configured to provide durable support for pivoting head mount 130.

In referring now to FIG. 3B, tripod 110 may include three support legs 200, three pivots 207, and base mount 240. Three support legs 200 may be fixed to base mount 240 and circumferentially distributed about center-axis 5. Each base-end 201 of each support leg 200 may be further configured to pivot radially outward from center-axis 5 via pivot 207 proximate to device-end 202 to enable tripod 110 to maintain a stand-alone condition.

In continuing to refer to FIG. 3B, each support leg further may have base-end 201 and device-end 202, and and may be extendable between minimum length 203 (FIG. 3A) and maximum length 205, respectively. It may be noted that maximum length 205 may be at least two times minimum length 203 (FIG. 3A). Base-end 201 of each support leg 200 may further be configured to pivot radially outward from center-axis 5 via pivot 207 proximate to device-end 202. Each support leg 200 of tripod 110 may further be structured and arranged to include first telescopic leg section 208 that may be configured to slide within second telescopic leg section 209, respectively. Because first telescopic leg section 208 may be configured to slide within second telescopic leg section 209, each support leg 200 may be configured to be placed in retracted position 211 (FIG. 3A), corresponding to minimum length 203 (FIG. 3A), and extended position 210, corresponding to maximum length 205. Minimum length 203 (FIG. 3A) of each of three support legs 200 may be approximately 8 inches 204 (FIG. 3A), and maximum length 205 of each of three support legs 200 may be at least 18 inches 206. Further, first telescopic leg section 208 may be configured to lock in extended position 210, and alternatively in retracted position 211 (FIG. 3A), via toolless locking mechanism 212 (FIG. 3A).

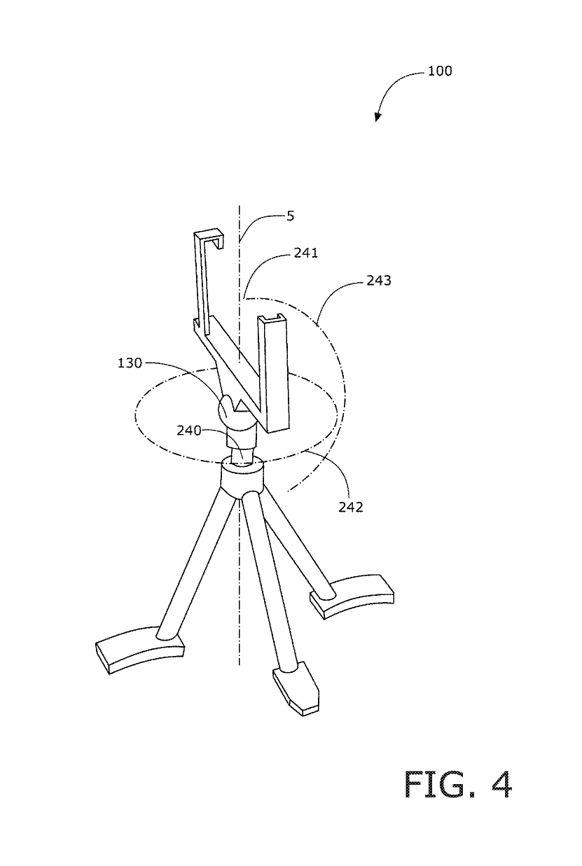

FIG. 4 is a perspective view of the stand for personal viewing of a mobile device 100 of FIG. 1A, according to an embodiment of the present disclosure. Pivoting head mount 130 may be configured for repeated engagement and disengagement of mobile device 25 (FIG. 1) in selectably fixed orientation 244 (FIG. 1A) facing user 140 (FIG. 1A and FIG. 1B). To enable user 140 (FIG. 1A and FIG. 1B) to selectably fix orientation 244 (FIG. 1A) of mobile device 25 (FIG. 1), pivoting head mount 130 may be coupled to base mount 240, with pivoting head mount 130 able to be configured to retain mobile device 25 (FIG. 2) to base mount 240. Further, pivoting head mount 130 may be able to provide at least two degrees of freedom 241 of motion, including pan 242 and tilt 243, while being retained to base mount 240. At least two degrees of freedom 241 of motion, including pan 242 and tilt 243, may further provide 180 degrees of tilt 243 through 360 degrees of pan 242 about center axis 5.

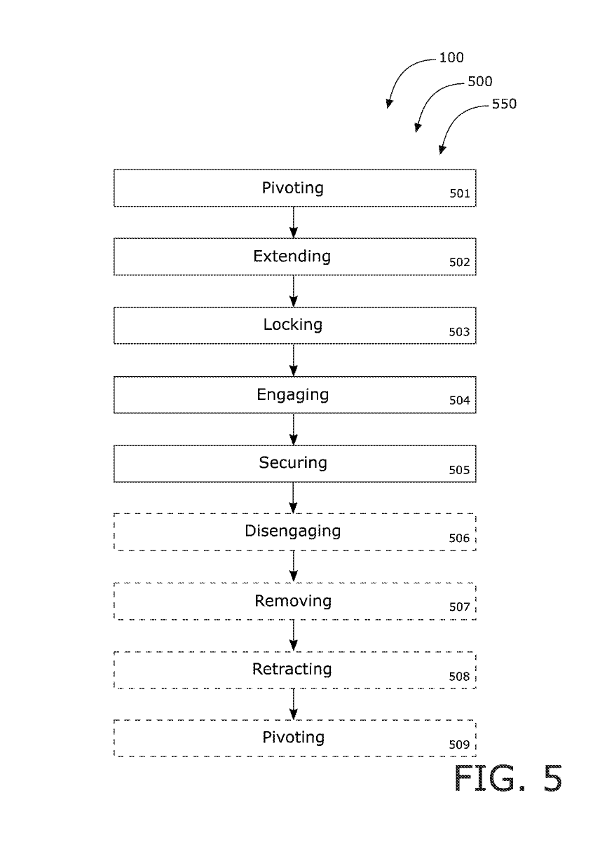

FIG. 5 is a flow diagram illustrating a method for personal viewing of a mobile device, according to an embodiment of the present disclosure. In particular, the method for personal viewing of a mobile device 500 may include one or more components or features of the a stand for personal viewing of a mobile device 100 as described above. As illustrated, the method for personal viewing of a mobile device 500 may include the steps of: step one 501, pivoting each support leg 200 radially outward from a center-axis 5 via a pivot 207 proximate to the device-end 202; step two 502, extending each support leg 200 to a desired extended position 210; step three 503, locking each support leg 200 via a toolless locking mechanism 212; step four 504, engaging a mobile device 25 into the first U-shaped channel 246 and second U-shaped channel 248 of the pivoting head mount 130; step five 505, securing the mobile device 25 with the device lock 249; step six 506, disengaging the device lock 249; step seven 507, removing the mobile device 25 from the first U-shaped channel 246 and the second U-shaped channel 248; step eight 508, retracting each support leg 200; and step nine 509 pivoting each support leg 200 radially inward toward the center-axis 5.

It should be noted that steps 506, 507, 508, and 509 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for personal viewing of a mobile device (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A stand for personal viewing of a mobile device, the stand comprising:
a tripod including three support legs, three pivots, and a base mount, the three support legs fixed to the base mount and circumferentially distributed about a center-axis, each support leg having a base-end and a device-end, and extendable between a minimum length and a maximum length, respectively, said maximum length being at least two times the minimum length, each base-end of said each support leg configured to pivot radially outward from said center-axis via a pivot proximate said device-end;
a user-interface including a plurality of non-slip pads, each non-slip pad coupled to the base-end of one of the three support legs, respectively, each non-slip pad configured to rest on the user; and
a pivoting head mount coupled to the base mount, said pivoting head mount configured to retain a mobile device to the base mount and to provide at least two degrees of freedom, including pan and tilt, while retained to said base mount.

2. The stand of claim 1, wherein the pivoting head mount includes a horizontal member, a vertical member, and a device lock, and is configured to hold said mobile device in a selectably fixed orientation facing the user;
wherein said horizontal member includes a first U-shaped channel configured to removably retain a first edge of said mobile device and inhibit motion along a first axis, said vertical member includes a second U-shaped channel configured to removably retain a second edge of said mobile device and inhibit motion along a second axis, said second axis orthogonal to said first axis; and
wherein said device lock is configured to selectably lock said mobile device into at least one of the first U-shaped channel and the second U-shaped channel.

3. The stand of claim 2, wherein the horizontal member, the vertical member, and the device lock are at least partially made of flexible elastomeric materials configured for repeated engagement and disengagement of said mobile device, without introduction of fatigue cracking of said horizontal member, vertical member, and device lock.

4. The stand of claim 1, wherein each support leg includes a first telescopic leg section configured to slide within a second telescopic leg section, respectively;
wherein each support leg is configured to be placed in a retracted position, corresponding to the minimum length, and an extended position, corresponding the maximum length; and
wherein said first telescopic leg section is configured to lock in said extended position, and alternatively in said retracted position, via a toolless locking mechanism.

5. The stand of claim 4, wherein the minimum length of each of the three support legs is approximately 8 inches, and the maximum length of each of the three support legs is at least 18 inches.

6. The stand of claim 4, wherein the three support legs are configured to retract radially inward toward the center-axis such that the three support legs are stowed substantially parallel with the center-axis.

7. The stand of claim 1, wherein the three support legs are at least partially made of metal, and alternatively, composite materials, and are configured to provide a durable support for the pivoting head mount.

8. The stand of claim 1, wherein each non-slip pad is structured and arranged to adjust from a first orientation to at least a second orientation relative to its respective support leg.

9. The stand of claim 8, wherein said first orientation and said second orientation pivotably range between 0 degrees and 180 degrees such that said each support leg is able to sustain contact on a body part of the user.

10. The stand of claim 9, wherein each non-slip pad is configured to sustain contact with a plurality of body parts of the user, with each non-slip pad having an independent orientation, and while plurality of body parts of the user are in motion.

11. The stand of claim 10, wherein each non-slip pad includes a curved base configured to conform to a leg of the user.

12. The stand of claim 8, wherein at least one non-slip pad is configured to removably attach to an article of clothing worn by the user.

13. The stand of claim 12, wherein the at least one non-slip pad includes at least one of a clip and a hook.

14. The stand of claim 1, wherein pivoting head mount is configured to selectably tilt said mobile device 180 degrees through 360 degrees of pan.

15. The stand of claim 1, wherein the pivoting head mount is configured to removably-retain a plurality of cell phone types.

16. The stand of claim 1, wherein said mobile device holder is configured to removably-retain a plurality of tablet device types.

17. A stand for personal viewing of a mobile device, the stand comprising:
a tripod including three support legs, three pivots, and a base mount, the three support legs fixed to the base mount and circumferentially distributed about a center-axis, each support leg having a base-end and a device-end, and extendable between a minimum length and a maximum length, respectively, said maximum length being at least two times the minimum length, each base-end of said each support leg configured to pivot radially outward from said center-axis via a pivot proximate said device-end;
a user-interface including a plurality of non-slip pads, each said non-slip pad coupled to the base-end of one of said three support legs, respectively, each said non-slip pad configured to rest on a user;
a pivoting head mount coupled to the base mount, said pivoting head mount configured to retain a mobile device to said base mount and to provide at least two degrees of freedom, including pan and tilt, while retained to said base mount;
wherein said pivoting head mount includes a horizontal member, a vertical member, and a device lock, and is configured to hold said mobile device in a selectably fixed orientation facing said user;
wherein said horizontal member includes a first U-shaped channel configured to removably retain a first edge of said mobile device and inhibit motion along a first axis, said vertical member includes a second U-shaped channel configured to removably retain a second edge of said mobile device and inhibit motion along a second axis, said second axis orthogonal to said first axis;
wherein said device lock is configured to selectably lock said mobile device into at least one of said first U-shaped channel and said second U-shaped channel;
wherein said horizontal member, said vertical member, and said device lock are at least partially made of flexible elastomeric materials configured for repeated engagement and disengagement of said mobile device, without introduction of fatigue cracking of said horizontal member, said vertical member, and said device lock;
wherein said each support leg includes a first telescopic leg section configured to slide within a second telescopic leg section, respectively;
wherein said each support leg is configured to be placed in a retracted position, corresponding to the minimum length, and an extended position, corresponding the maximum length;
wherein said first telescopic leg section is configured to lock in said extended position, and alternatively in said retracted position, via a toolless locking mechanism;
wherein said minimum length of each of the three support legs is approximately 8 inches, and said maximum length of each of the three support legs is at least 18 inches;
wherein said three support legs are configured to retract radially inward toward said center-axis such that said three support legs are stowed substantially parallel with said center-axis;
wherein said three support legs are at least partially made of metal, and alternatively, composite materials, and are configured to provide a durable support for said pivoting head mount;
wherein said each non-slip pad is structured and arranged to adjust from a first orientation to at least a second orientation relative to its respective said each support leg;
wherein said first orientation and said second orientation pivotably range between 0 degrees and 180 degrees such that said each support leg is able to sustain contact on a body part of said user;
wherein said each non-slip pad is configured to sustain contact with a plurality of body parts of said user, with each non-slip pad having an independent orientation, and while said plurality of body parts of said user are in motion;
wherein said each non-slip pad includes a curved base configured to conform to a leg of said user;
wherein said at least one non-slip pad is configured to removably attach to an article of clothing worn by said user;
wherein said at least one non-slip pad includes at least one of a clip and a hook;
wherein said pivoting head mount is configured to selectably tilt said mobile device 180 degrees through 360 degrees of pan;
wherein said pivoting head mount is configured to removably-retain a plurality of cell phone types; and
wherein said mobile device holder is configured to removably-retain a plurality of tablet device types.

18. The hands-free mobile device holder system of claim 17 further comprising a set of user instructions; and wherein the hands-free mobile device holder system is arranged as a kit.

19. A method of using a hands-free mobile device holder system comprising the steps of:
pivoting each support leg radially outward from a center-axis via a pivot proximate to the device-end;
extending each support leg to a desired length;
locking each support leg via a toolless locking mechanism;
engaging a mobile device into the first U-shaped channel and second U-shaped channel of the pivoting head mount; and
securing the mobile device with the device lock.

20. The method of claim 19 further comprising the steps of: disengaging said device lock; removing said mobile device from said first U-shaped channel and said second U-shaped channel; retracting said each support leg; and pivoting said each support leg radially inward toward the center-axis.
